(19) United States
(12) Patent Application Publication
(10) Pub. No.: US 2016/0293052 A1
(43) Pub. Date: Oct. 6, 2016

(54) PEDAGOGICAL SYSTEM

(71) Applicant: Robert William SAPORA, Westminster, MD (US)

(72) Inventor: Robert William SAPORA, Westminster, MD (US)

(21) Appl. No.: 14/674,090

(22) Filed: Mar. 31, 2015

(51) Int. Cl. G09B 23/00; G09B 23/04; G09B 23/06

(52) U.S. Cl. CPC G09B 23/00; G09B 23/06; G09B 23/04

(57) ABSTRACT

An entertaining ball-rolling table game that generates the desire to understand and use the physics, dynamics and geometry incorporated in the game is provided. The game may include a game table providing a sloped table surface forming two vortical holes. The game is played by rolling one ball bearing at a time along the table surface with the purpose of rolling the ball bearing into a predetermined vortical hole. At the beginning of a player's experience with the game, it will seem extremely difficult to aim the ball with enough precision to guarantee that the ball will fall into one hole rather than the other. The precision and subtlety of the surface of the game table and its interface with the ball bearing makes it uniquely hard to understand, but uniquely challenging, and thus uniquely gratifying to master, and so generate the desire to problem solve and understand the STEM knowledge at play. Further, the system that embodies the game may provide further analysis and knowledge-building by representing physical parameters from previous rolls for the participants to observe and apply to future rolls.

### BACKGROUND OF THE INVENTION

The present invention relates to pedagogical systems and, more particularly, to a system embodying an educational device for demonstrating concepts of gravity, physics, dynamics and geometry.

The importance of STEM (science/technology/engineering/math) education for economic growth and national security is well established.

Unfortunately, many STEM-based school courses are off-putting and boring to many students, often consisting solely of static textbook illustrations, spoon-fed mathematics, and rote memorization of scientific dogma. Students memorize what scientists assert about reality rather than learning to act scientifically in order to discover the truth about reality for themselves. As a result, today's students are encouraged to become passive, non-skeptical consumers of scientific assertions rather than to become active and self-challenging producers of useful scientific knowledge.

First, classroom/textbook treatment of STEM subject matter is disadvantaged by not presenting a hands-on, empirical, problem-solving challenge as the primary engine of learning. Moreover, STEM students rarely receive knowledge from a didactic textbook, since knowledge signifies understanding of real things or abstract concepts, and such understanding is best developed through observation, discovery and invention. Standard textbook treatment begins and ends with deductive exposition, which is shown by peer-reviewed research to be less effective in engaging students than open-ended problem solving, which develops deeper conceptual understanding. As a result, some otherwise promising students will never be engaged by the kind of education described above and will thus never contribute to the advancement of STEM knowledge.

As can be seen, there is a need for an engaging and entertaining problem-solving game that generates the desire to understand and use the physics, dynamics and geometry incorporated in the game.

### SUMMARY OF THE INVENTION

In one aspect of the present invention, an educational device provides a generally elliptical surface forming two vortical holes, wherein each vortical hole is disposed along a center of the elliptical surface; an inward slope formed along the elliptical surface so that the elliptical surface subtly slopes toward its center; and at least one ball bearing of sufficient weight, such that when the ball bearing rolls on the elliptical surface, a rolling trajectory of the at least one ball bearing is problematic to predict.

In another embodiment of the present invention a method of providing an engaging and entertaining problem-solving game that generates the desire to understand and use the physics, dynamics and geometry incorporated in the game includes providing a generally elliptical surface forming two vortical holes, wherein each vortical hole is disposed near a center of the elliptical surface, and wherein the elliptical surface has an inward slope formed along the elliptical surface so that the elliptical surface subtly slopes toward its center; providing at least one ball bearing of sufficient weight, such that when the ball bearing rolls on the elliptical surface, a rolling trajectory of the at least one ball bearing is problematic to predict; choosing a predetermined vortical hole of the two vortical holes; and rolling the at least one ball bearing from a predetermine location along a periphery of the elliptical surface so that an end result is a pathway rolled by the at least one ball bearing that terminates in the predetermined vortical hole.

In yet another embodiment of the present invention educational system includes an educational device providing: a generally elliptical surface forming two vortical holes, wherein each vortical hole is disposed near a center of the elliptical surface; an inward slope formed along the elliptical surface so that the elliptical surface subtly slopes toward its center; and at least one ball bearing of sufficient weight, such that when the ball bearing rolls on the elliptical surface, a rolling trajectory of the at least one ball bearing is problematic to predict; a computer; a computer scanning device electronically connected to the computer, wherein the computer scanning device is focused on the elliptical surface, and wherein the computer scanning device is configured to capture physical parameters of the at least one ball bearing rolling along the elliptical surface; and a feedback mechanism electronically connected to the computer, wherein the feedback mechanism is configured to electronically represent the captured physical parameters.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a section view of an exemplary embodiment of the present invention, taken along line 2-2 in FIG. 1;

FIG. 3 is a section view of an exemplary embodiment of the present invention, taken along line 3-3 in FIG. 1; and

FIG. 4 is an oblique perspective view of an illustrative embodiment of a table surface of the present invention. The grid is not a visible feature of the table surface, itself, but is added to FIG. 4 to aid in visualizing the complex curvature thereof.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an entertaining ball-rolling table game that generates the desire to understand and use the physics, dynamics and geometry incorporated therein. The game may include a game table providing a sloped table surface forming two vortical holes. The game is played by rolling one ball bearing at a time along the table surface with the purpose of rolling the ball bearing into a predetermined vortical hole. At the beginning of a player's experience with the game, it will seem extremely difficult to aim the ball with enough precision to guarantee that the ball will fall into one hole rather than the other. The precision and subtlety of the surface of the game table and its interface with the ball bearing makes it uniquely hard to understand, but uniquely challenging, and thus uniquely gratifying to master, and so generate the desire to problem solve and understand the STEM knowledge at play. Further, the system that embodies the game may provide further analysis and knowledge-building by representing physical parameters from previous rolls for the participants to observe and apply to future rolls.

The present invention includes a pedagogical system 100 embodying an educational device 10 for demonstrating concepts of gravity, physics, dynamics and geometry. The educational device 10 provides, among other things, an entertaining, empirical problem-solving game that generates the desire to understand and use the physics and dynamics and geometry incorporated in the game. The game presents a challenge that can be solved using inductive tools that students themselves invent. Mastering the game looks simple at first glance but proves very difficult, as the game responds to no obvious tricks and manifests many improbable and surprising behaviors. This encourages students to develop improved scientific skills and builds confidence in problem-solving on their own. The pedagogical system 100 may provide a computer scanning device 20 adapted to capture the problem solving inherent in the game playing so that participants and students of the game can review for further analysis and learning.

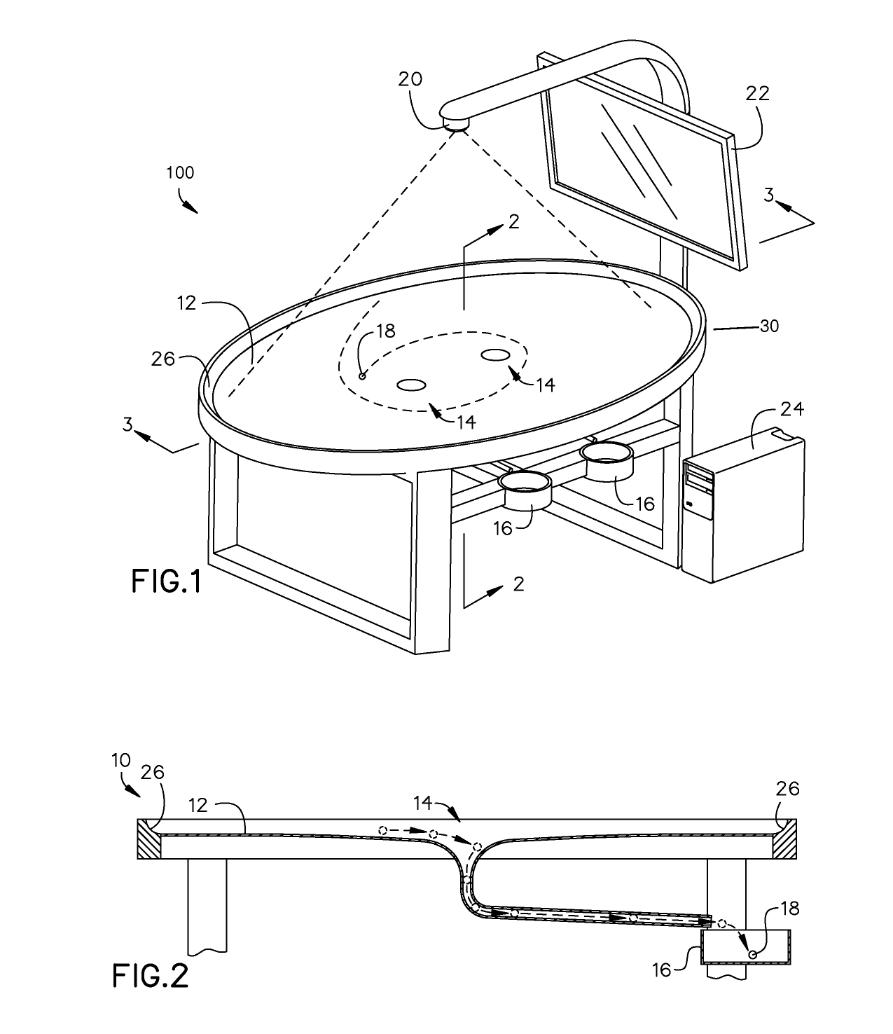

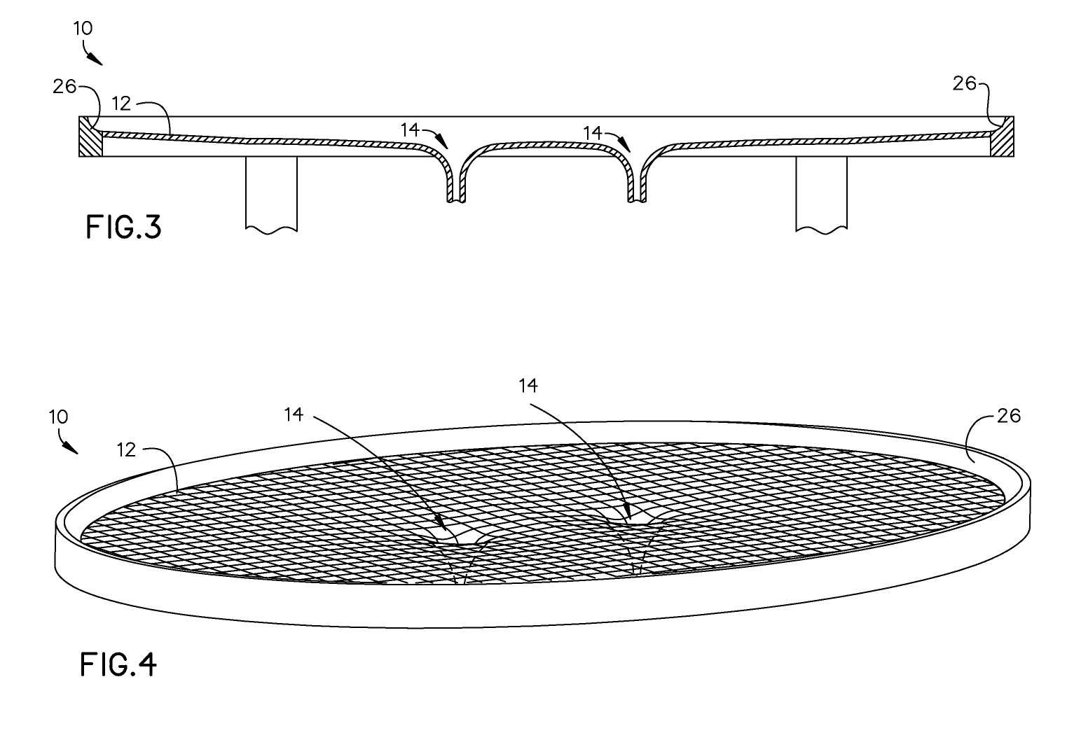

Referring to FIGS. 1-4, the educational device 10 may include a game table 30 having a table surface 12 that forms two vortical holes 14. In certain embodiments, each vortical hole 14 may communicate with an associated collection bin 16. The educational device 10 may include a plurality of unique ball bearing 18 adapted to roll along the table surface 12 and sized to be received by either vortical hole 14. Each ball bearing 18 may be sphere, spheroid, ball-like shape or the like and have a suitable weight and size in order to facilitate the unpredictable nature of rolling on the table surface 12.

The game table 30 may provide a table border 26 along its periphery so as to suitably support the table surface 12. The associated collection bins 16 may be disposed so that the participant can accurately observe which associated vortical hole 14 a given rolled ball bearing 18 has dropped through; for example, making the associated collection bins 16 visible despite the table border 26.

The table surface 12 may be generally elliptical in shape, when oriented as a landscape. The table surface 12 generally slopes inwardly/downwardly toward its center. The two vortical holes 14 may be disposed along the major axis of the elliptical table surface 12, between its center and its two focal points. The geometry of the table surface 12 may provide a subtle inward slope expressed by the function f(x)=S×1/x, where S (slope) is a quantity that must fall in a very narrow range of tolerance. In particular, as the table surface 12 approaches the vortical holes 14, it is no longer simply an image of the function f(x)=S×1/x. Rather, the surface near the holes becomes so complex as to require the introduction of overlapping local patches with smooth, real-number Euclidian coordinates and (X,Y)→(x,y) continuity from patch to patch. As students discover this feature of the table surface 12, they acquire a number of powerful concepts of the math of Einsteinian gravity. The geometry of the table surface 12 is complicated but overall continuous though complex topological functions and differentiable, providing a surface about which players will develop, discover and formulate intuitive knowledge as they repeatedly roll the same ball bearing 18.

The table surface 12 may be made of an interface sensitive medium adapted to interface with the weight and size of the ball bearing 18 in order to make the trajectory of any given roll maximally problematic to predict, for example by adapting the coefficient of friction so as to affect the rolling friction. This is also necessary so that at the more advanced levels of the game, the participant is actually inventing an algebraic and/or geometric model of Einsteinian concepts with the specially adapted computer 24.

The pedagogical system 100 may also include a computer scanning device 20, such as a 3D scanner, focused on the game table 30 so as to visually record the resulting game playing. The computer scanning device 20 may be electronically connected to a computer 24 having at least one processing unit and a form of memory, wherein the computer 24 may be adapted to collect and analyze physical parameters of the game playing including, but not limited to, the ball bearing's 18 trajectory in Cartesian 3-tuples and instantaneous velocity with respect to the table surface 12. The computer scanning device 20 may include an array of cameras placed such that an unambiguous record of the physical parameters of a given roll can be recorded according to the data protocols of the specialized computer 24, for example by means of triangulation from guide points etched into the game table 30 or table surface 12. The computer 24 may be matched as naturally as possible to make the participant's efforts at algebraic and/or geometric modeling as intuitive as possible, without any unnecessary systemic computational clumsiness. The computer 24 may be electronically connected to a feedback mechanism 22, such as a video screen, so as to electronically represent the collected, analyzed physical parameters and/or visual recordings of the game playing for the participant and others to observe during the game playing and thereafter. Thereby, the participant may perfect his or her technique by analyzing on the feedback mechanism 22 the effects of the changes incorporated in each tweaked “next” roll.

A method of making the present invention may include the following. An individual may form the table surface 12 out of transparent acetate sheet on a negative mold. The game table 30 may be suspended either on legs or with a monofilament rigging system from the ceiling. The scale of the overall pedagogical system 100 will be determined by the installation space provided. Each collection bin 16 may be made with rigid acetate pipe attached on one end to the bottom of each vortical holes 14 and on the other end with labeled bowls near where the participant stands to operate the game so that participants and observers can keep track of the results of cumulative rolls.

The method of using present invention includes providing the pedagogical system 100 disclosed above. The pedagogical system 100 embodies a game for a plurality of players to discover and formulate informed choices by looping through a sequence of unique steps performed in temporal order in one of two possible recycling loops; namely, (1-2-3) or (1-2-3-4-5).

In step 1, a game player selects a unique, identifiable ball bearing 18.

In step 2, each player chooses a point anywhere around the edge of the game table 30 and rolls his or her unique ball bearing 18, attempting to have it drop through a predetermined vortical hole and not the other. The ball bearing 18 take their course as gravity and the table surface 12 dictate, falling either through the intended predetermined vortical hole 14 or through its opposite. The usual difference in frequency between the intended predetermined vortical hole 14 and its opposite is <4%.

In step 3, each player's informed choice is either partially confirmed or challenged as the unique ball bearings 18 roll to the collection bin 16 associated with the predetermined vortical hole 14 or its opposite.

After step 3 of the fully realized system, two pathways for further action are available: (a) the player can return to step 1 and repeat the game from step 1 through step 3 in order to reflect intuitively on the nature of the game and in order to improve on techniques intended to increase success; or (b) the player can move to a computer terminal and continue with steps 4 and 5.

In step 4, the player may review a 3D image of his or her roll in order to sharpen and enhance his or her intuitions about why the roll went as it did and how his accuracy might be improved.

In step 5, the physical parameters of the game playing collected may be analyzed by any game player to significantly increase their success of future rolls. Such improvement will involve acquiring knowledge of several concepts of mathematics and physics. Players with the desire to improve at the game will be guided at this point by prompts in the software of the computer 24 to pursue projects that supply such knowledge.

The experience recycling through the loops will provide the hands-on basis for intuitive improvements of game-playing skill on the part of players. As players perfect their command over the mathematics of said functions, they will be getting more and more ready to discover mathematical concepts of Einstein's ideas about gravity in their own mathematical language.

The present invention may be installed as a novel exhibit in a science museum or children's museum, or one would use it in lieu of traditional textbook teaching in a school or college science curriculum. Thus, in either use application, a novel game would take its place as a promising novel feature in STEM pedagogy.

Additionally: Advanced programs in the pedagogy of STEM subjects could use the present invention as the first unit in courses on curriculum development. Further, the present invention could be used as the base device for a system of devices that would lead to a broader range of Einsteinian and other models of post-Newtonian physics. Further, students could be required to design and perhaps even build prototypes of other similar devices to illustrate related concepts of physics.

Also, it can create: As in Montessori schooling, where successful student solutions of a given problem are gathered in an album to inspire other students to find their own novel solutions, various successful game solutions can be archived for all players to consult after they have completed their own progress toward success.

It should be understood, of course, that the foregoing relates to exemplary embodiments of the invention and that modifications may be made without departing from the spirit and scope of the invention as set forth in the following claims.

What is claimed is:

1. An educational device comprising:
a generally elliptical surface forming two vortical holes, wherein each vortical hole is disposed along a center of the elliptical surface;
an inward slope formed along the elliptical surface so that the elliptical surface subtly slopes toward its center; and
at least one ball bearing of sufficient weight, such that when the ball bearing rolls on the elliptical surface, a rolling trajectory of the at least one ball bearing is problematic to predict.

2. The educational device of claim 1, wherein each vortical hole is disposed along a major axis between the center and each focal point of the elliptical surface.

3. The educational device of claim 1, wherein the elliptical surface is made of an interface sensitive medium, such that the interface surface medium makes the rolling trajectory problematic to predict.

4. The educational device of claim 1, further comprising a collection bin associated and in communication with each vortical hole.

5. The educational device of claim 1, further comprising a game table, wherein the elliptical surface forms a table surface of the game table.

6. The educational device of claim 1, wherein the inward slope exhibits a continuous and differentiable topological function.

7. The educational device of claim 1, wherein the continuous and differentiable topological function is generally expressed by f(x)=S×1/x.

8. The educational device of claim 6, wherein a portion of the inward slope along each vortical hole exhibits a complexity that cannot be expressed by f(x)=S×1/x.

9. An educational system, comprising:
an educational device comprising:
a generally elliptical surface forming two vortical holes, wherein each vortical hole is disposed near a center of the elliptical surface;
an inward slope formed along the elliptical surface so that the elliptical surface subtly slopes toward its center; and
at least one ball bearing of sufficient weight, such that when the ball bearing rolls on the elliptical surface, a rolling trajectory of the at least one ball bearing is problematic to predict;
a computer;
a computer scanning device electronically connected to the computer, wherein the computer scanning device is focused on the elliptical surface, and wherein the computer scanning device is configured to capture physical parameters of the at least one ball bearing rolling along the elliptical surface; and
a feedback mechanism electronically connected to the computer, wherein the feedback mechanism is configured to electronically represent the captured physical parameters.

10. The educational system of claim 9, wherein the feedback mechanism is a video screen.

11. The educational system of claim 9, wherein the computer scanning device is a three-dimensional scanner.

12. The educational system of claim 9, further comprising a software application loaded onto the computer, wherein the software application is configured to prompt questions pertaining to the captured physical parameters.

13. A method of providing an engaging and entertaining problem-solving game that generates the desire to understand and use the physics, dynamics and geometry incorporated in the game, comprising:
providing a generally elliptical surface forming two vortical holes, wherein each vortical hole is disposed near a center of the elliptical surface, and wherein the elliptical surface has an inward slope formed along the elliptical surface so that the elliptical surface subtly slopes toward its center;
providing at least one ball bearing of sufficient weight, such that when the ball bearing rolls on the elliptical surface, a rolling trajectory of the at least one ball bearing is problematic to predict;
choosing a predetermined vortical hole of the two vortical holes; and
rolling the at least one ball bearing from a predetermine location along a periphery of the elliptical surface so that an end result is a pathway rolled by the at least one ball bearing that terminates in the predetermined vortical hole.

14. The method of claim 13, further providing reflecting intuitively on the end result, the pathway rolled, and the predetermine location of each previous rolling.

15. The method of claim 14, further providing rolling the at least one ball bearing from a new predetermine location along the periphery of the elliptical surface so that the end result is that a new pathway rolled by the at least one ball bearing terminate in the predetermined vortical hole.

16. The method of claim 13, further comprising:
providing a computer;
providing a computer scanning device electronically connected to the computer, wherein the computer scanning device is focused on the elliptical surface, and wherein the computer scanning device is configured to capture physical parameters of the at least one ball bearing rolling along the elliptical surface; and
providing a feedback mechanism electronically connected to the computer, wherein the feedback mechanism is configured to electronically represent the captured physical parameters.

17. The method of claim 16, further comprising reviewing at least one three-dimensional image from the computer scanning device of at least one previous roll so as to reflect intuitively on the end result, the pathway rolled, and the predetermined location of at least one previous roll.

18. The method of claim 16, further comprising reviewing an electronic representation on the feedback mechanism of at least one previous roll so as to reflect intuitively on the end result, the pathway rolled, and the predetermined location of at least one previous roll.
